(19) United States
(12) Patent Application Publication
(10) Pub. No.: US 2005/0134611 A1
(43) Pub. Date: Jun. 23, 2005

(54) Mechanism for creating dynamic 3D graphics for 2D web applications

(76) Inventor: Kevin Robert Cheung, Sunnyvale, CA (US)

Correspondence Address: KEVIN CHEUNG, 1170 SILVERLAKE DR., SUNNYVALE, CA, 94089, US

(21) Appl. No.: 11/004,832

(22) Filed: Dec. 7, 2004

Related U.S. Application Data
(60) Provisional application No. 60/527,841, filed on Dec. 9, 2003.

(51) Int. Cl. G06T 13/00

(52) U.S. Cl. 345/664

(57) ABSTRACT

This invention describes a process that allows 3D graphics to be rendered on a 2D capable client system by aggregating the data on the server side through a plurality of machines.

### CROSS-REFERENCE TO RELATED APPLICATIONS

This application claims benefit of PPA Ser. No. 60/527,841.

### FEDERALLY SPONSERED RESEARCH

Not Applicable

### SEQUENCE LISTING OR PROGRAM

Not Applicable

### BACKGROUND OF THE INVENTION—FIELD OF INVENTION

This invention relates generally to the field of telecommunications and, more particularly, to a system and method for more effectively rendering on a server computer and transferring image data across the network to a remote computer.

### BACKGROUND OF THE INVENTION

3D graphics are usually used only on computers with specific 3D accelerators or machines with very fast CPUs. Although 3D is moving quickly into the consumer area, there are still a wide variety of accelerators and CPU configurations, making it difficult to deliver consistent 3D performance on all machines. In addition, there are still many machines without 3D acceleration that could benefit from viewing graphics in 3D.

In recent years video games have become more 3D-oriented. Users now expect to see 3D graphics when they play a game. This experience is normally delivered on a console with 3D acceleration, to reach a wider audience. This invention gives a method to expand this audience to include 2D enabled computers.

There needs to be a means by which an engineer can create an application with specific 3D components that can be used by any computer capable of displaying 2D graphics in a web browser.

There also needs to be a way to de-couple the graphics requirements from the client computer side. With technology changing rapidly, only some users see the benefits of this if they upgrade their machines, limiting the scope of programs that take advantage of the extra power.

### BACKGROUND—DISCUSSION OF THE PRIOR ART

In the past, other systems have used server side rendering to speed up display on a client sys-tem with limited 3D capabilities.

Prior systems have never attempted to re-use the results of a previous render.

Other server based rendering systems have been restricted to customized technologies on both the client and server sides resulting in an improved speed of 3D display, but only on machines specifically configured for 3D graphics or video input.

Other server side rendering systems have used a proxy method for generation of graphics, making it difficult to distribute the work across multiple machines, this limits the speed of the server side render to the fastest machine on the server side.

There are also claims that cover the translation of 3D data into 2D images, however these claims have no ability to generate the images in real time based upon user specific data.

Prior systems have been based on proprietary encoding and protocols, limiting the portability of the data.

Prior art has been restricted to a system that only has one vector of animation encoded into the 2D image. This allowed a 3D view, but with very limited variety of views available.

### BACKGROUND OF THE INVENTION—OBJECTS AND ADVANTAGES

The problems put forth in the above paragraphs can be solved through a system that allows the 3D graphics to be placed into a 2D context with multiple views of the 3D item taken as animations and rotations. This package can be sent as a single or a plurality of images, allowing the client side to display at will any number of orientations of the 3D object.

Another advantage is, this invention targets a 2D web browser running common “plug-in” soft-ware technology. An example of this type of technology is Macromedia Flash, a web-based animation tool which allows fast manipulation of 2D images. By targeting a common format for the animated images, the restrictions on which machines are able to display the graphics goes away.

On the server side this invention does not specify a single rendering technology, the technology used to render the 2D images is independent of the system that prepares and packages the graphics for delivery to the client. This has the advantage of allowing the system to scale and change as new technology becomes available.

The object used to create the 2D renders suits itself well to parallel rendering technology. This invention takes advantage of this economy of scale. In recent years the price for computing power has steadily decreased, it is now reasonable to configure multiple machines with similar capabilities to handle the distribution of multiple renders.

This system uses a database to save the results of previous renders, the logic being that many users will want to view the same graphic renders. The database object has the advantage of increasing the performance of the overall system by making sure duplicate renders do not occur.

The invention uses a common form of data transmission to encode the user specifications for 3D views and animation required, this allows the data to be processed by a number different tools.

### SUMMARY

In accordance with the present invention a process by which custom 3D graphics can be rendered on a network connected computer with only 2D, or limited 3D capability.

### DRAWINGS—FIGURES

FIG. 1 shows all of the hardware components of the invention along with how they are connected.

FIG. 2 shows a flowchart of the dataflow through the system. There are four columns, each depicting one of the major hardware components, and lines between them showing the path of data travel.

FIG. 3 details how the 3D rendered images can be tiled into a 2D image for transmission to the client.

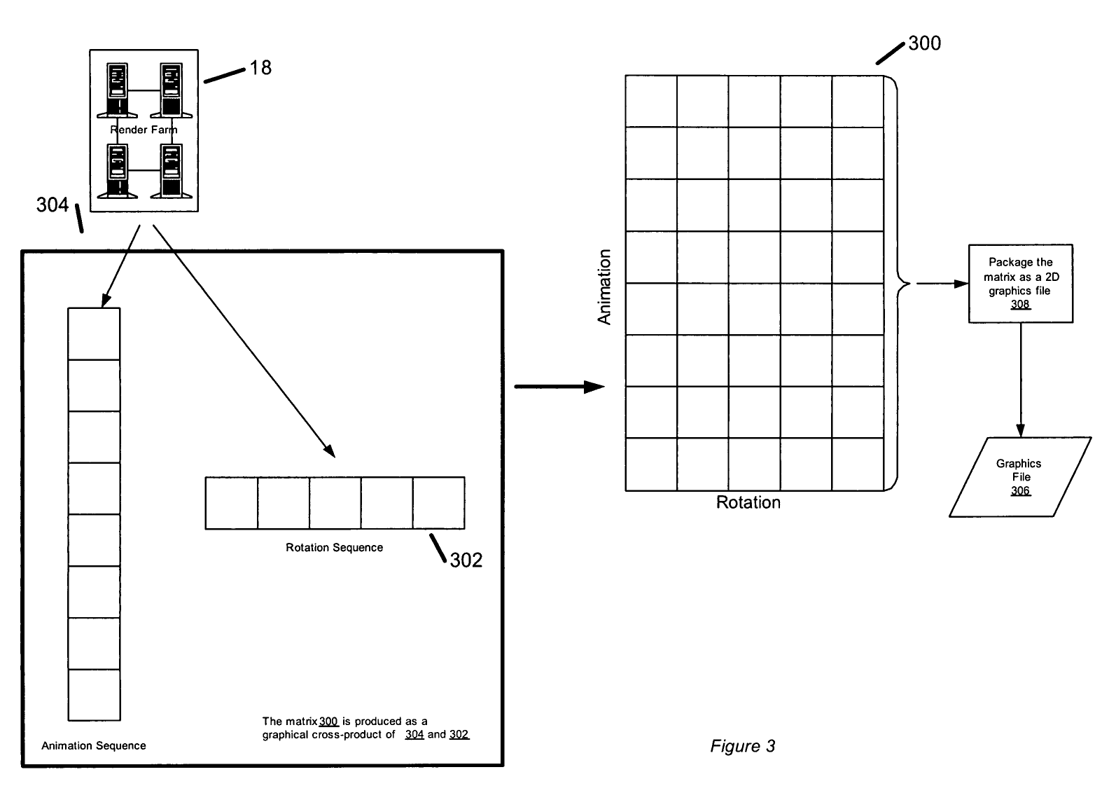

While the invention is susceptible to various modifications and alternative forms, specific embodiments thereof are shown by way of example in the drawings and detailed description thereto are not intended to limit the invention to a particular form disclosed but on the contrary, the intention is to cover all modifications, equivalents and alternatives falling within the spirit and scope of the present invention as defined by the appended claims. Note, the headings are for organizational purposes only and are not meant to be used to limit or interpret description or claims. Furthermore, note that the word “may” is used throughout this application in a permissive sense (i.e., having the potential to, being able to), not a mandatory sense (i.e. must). “The term “include”, and derivations thereof, mean “including, but not limited to”. The term connected means “directly or indirectly connected”, and the term “coupled” means directly or indirectly connected”.

### Drawings-List of Reference Numerals

10 Client Machine
12 Wide Area Network connection
14 Server Machine
16 Database
18 Rendering farm
200 Start client process
204 2D graphics render
208 Decision to request 3D graphics
212 End of client render loop
220 Server request for 3D graphics
224 Client receives new 3D graphics set
228 Start server process
232 Receive client request
234 Create a fingerprint for the request
236 Check database for the fingerprint
240 Server request to render farm
242 Database query
248 Receive new graphics set
252 Send the 3D graphics set to the client
256 Server farm start
260 Receive a server farm request
264 Render the 3D graphics
272 Send the 3D graphics set to the server
274 Lookup fingerprint in the database
278 Save a 3D set in the database
300 2D matrix of 3D images, the 3D set
302 One rotation sequence
304 Cross product operation on multiple sequences
306 Encode the 3D set in a common 2D format
308 Package the 3D renders as a 3D graphics set

### DETAILED DESCRIPTION OF THE PREFERRED EMBODIMENTS

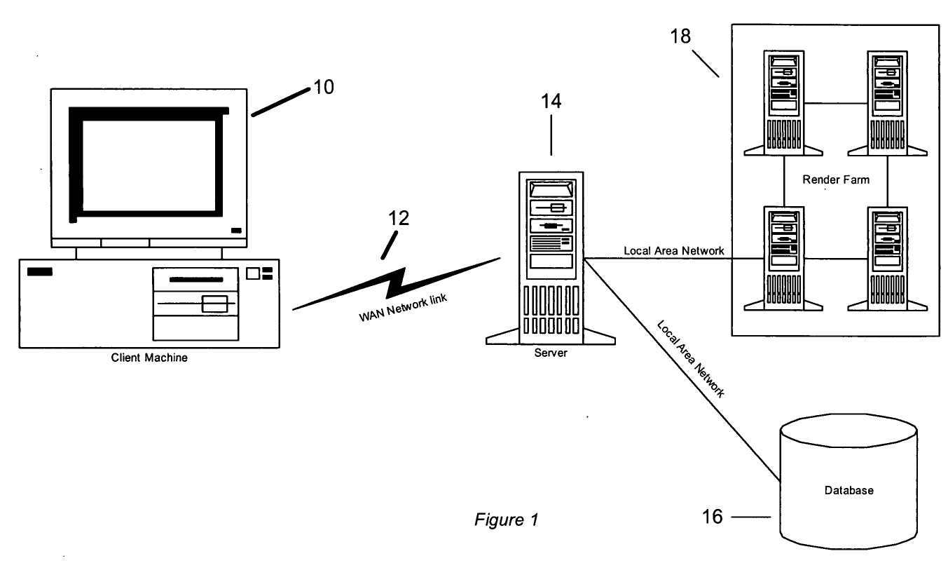

Hardware components—FIG. 1

FIG. 1 illustrates one embodiment of the complete system and the connections between each component.

The client 10 has a graphics system capable of displaying 2D graphics and a web browser, with an appropriate plug-in. The client is not restricted to a computer, and can include any machine that has a screen capable of displaying 2D graphics and communicating over a network. Other devices like this are HDTV boxes, video game consoles, and cable decoders.

The client is attached to some kind of Wide Area Network (WAN) 12. The network provides connection to some arbitrary server that provides the 3D graphics service. When 3D graphics are required the client requests this through an XML message to the server.

The server 14 depicted in FIG. 1 is used to distribute applications that require 3D in the display.

The server farm 18 is a plurality of machines designed specifically to render 3D images in a variety of animation stages and rotations. The server 14 sends an XML request to the server farm which takes the result and packages the graphics for shipment to the client 10.

The database 16 is used as a cache of previously rendered 3D images. The database uses unique fingerprints to identify specific renders. The server can query the database for a specific fingerprint, and if it is found the pre-rendered data can be retrieved, eliminating the need to use the render farm to create the graphics.

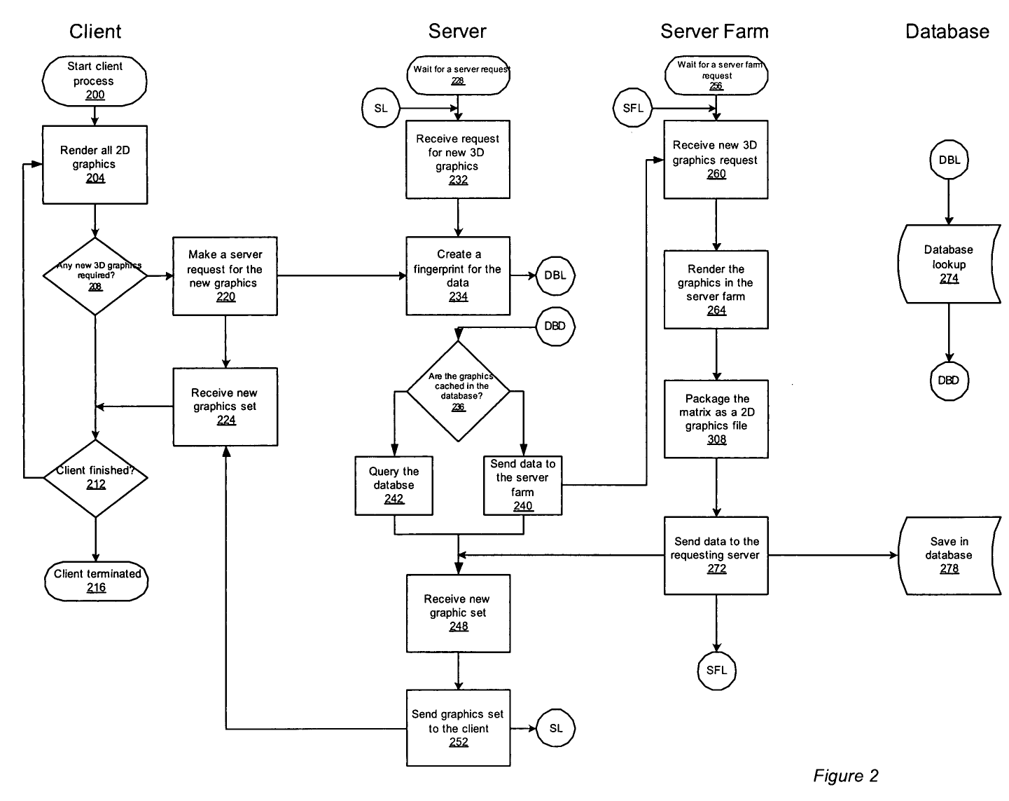

FIG. 2 shows in detail the process required to request and deliver the graphics to the client machine.

The system consists of four distinct processes which may run on separate machines and each perform a separate job. All of the process start up and wait for requests. The client 200 starts when a user requests an application that requires 3D. The server starts up 228 before the client's first 3D request. The server farm 256 must start before the first request to render frames and the database 16 must be started before the first query into the database.

The client renders all of the 2D graphics it can 204. When it requires a new 3D rendering, it must make a request to t he server 208. The request may be sent via an XML message to the server 220. Upon receipt of the XML message the server then creates a fingerprint for the data request 234. The algorithm for creation of the fingerprint may be a simple cross-product of all of the data vectors to yield a unique identifier for the request.

Once the fingerprint is computed, the server may then query the database to see if the requested graphics have already been rendered and saved 236.

The database will lookup in a cache, which may be of variable size, for the requested fingerprint 274. If the database query returns a successful hit, the server will request the data from the data-base 242. If the database lookup fails the server will submit a request to the server farm to have the graphics rendered 240.

When a new graphics request is received by the server farm 260, the render farm 18 takes the request, decomposes the request into equal sized pieces and then sends the request to be processed by the rest of the server farm 264.

The server farm renders all of the 3D vectors specified by the server request. The API for this render is unspecified, the server farm has a way of displaying the renders in a frame buffer and capturing the render as a 2D image which is saved for the packaging step 308.

When the render is completed, the server farm takes the component renders and assembles them into a set of 2D graphics that can be shipped to the client 308.

The procedure to package the graphics for the client involves taking the cross product of sequences produced by the render farm 18. The sequences may include any number of vectors, but it is the easiest to explain the procedure for two vectors. The render farm will produce sequences for each of the vectors. By taking the first sequence 302 and the second sequence 304 we can enumerate across all the possible combinations to produce a grid that represents the cross product of the 2 vectors 300. This grid takes the form of a 2D image consisting of the combination of the 2 vectors. This can be expanded to a third vector by using multiple 2D images and beyond that we must use sets of 2D images to encapsulate the additional vectors 308.

Once the 2D images have been assembled into the grid 300, the farm then packages the 2D file for transmission to the client. This may involve converting the image to a specified color depth and formatting the data in a well known graphics file format, such as the PNG (Portable Network Graphics) format 308. The result is a file or set of files encapsulating the necessary 3D information in 2D format 306. The server farm then goes back to waiting for a server farm request 256.

With the 2D graphics packaged 306, the server farm takes these packages and stores them in the database 278. The key for the data may be the fingerprint generated by the server in 234. The data will also be sent back to the server with the client as its final destination 248. The server then sends the data package back to the client as a response to the original XML query 252. The server then waits for a new query from a plurality of clients 228.

The client then takes the completed graphics request and uses the data received to render the 3D graphics 244. The client will continue processing data 212 until it terminates 216.

Although the embodiments above have been described in considerable detail, other versions are possible. Numerous variations and modifications will be apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

1. A method allowing 3d graphics to be displayed on a 2d capable client machine, comprising:
(a) Providing a client machine capable of 2d graphics and connection to a server machine.
(b) Providing a server that can aggregate and process requests from the client.
(c) Providing a render farm consisting of a plurality of machines used to process requests from the server on behalf of the client, which:
(1) Provides the 3d renders necessary to fulfil said client's request for data.
(2) Provides a process to allow the data to be sent back to the said client via said server.
(3) provide a fingerprint for each client request.
(d) Providing a database which will:
(1)Provide storage for the output of the render farm.

2. The method of claim 1 wherein the client can be any 2D application of plug-in software where the 3D facilities of the system are not used or required.

3. The method of claim 1 wherein the database used to recall previously generated renders can store any number of previous renders from 0 to n renders, where a database that stores 0 renders is equivalent to eliminating the database from the mechanism.

4. The method of claim 1 wherein the 3D graphics are rendered by an unspecified technology or graphics API.

5. The method of claim 1 wherein the fingerprint is computed from a unique set of attributes extracted from the request sent from the client.

6. The method of claim 1 wherein the 2D format of the target data is not specified, but is understood by the client.
